(19) United States
(12) Patent Application Publication
(10) Pub. No.: US 2025/0376235 A1
(43) Pub. Date: Dec. 11, 2025

(54) Two Wheel Toy with Electric motor

(71) Applicant: Reginald Keith Sapp, CLINTON, MD (US)

(72) Inventor: Reginald Keith Sapp, CLINTON, MD (US)

(21) Appl. No.: 18/748,275

(22) Filed: Jun. 20, 2024

(51) Int. Cl. B62K 3/00; B62K 23/02

(52) U.S. Cl. CPC B62K 3/002; B62K 23/02; B62K 2202/00

(57) ABSTRACT

The two wheel toy with electric motor FIG. 1 and platform FIG. 1F with Handbrakes FIG. 1A (Right), FIG. 1B (Left) is propelled by FIG. 1C throttle, FIG. 1J (the Battery), FIG. 1I (The Electric Motor), FIG. 1H (The Shaft) to the Rear Wheel FIG. 1G.

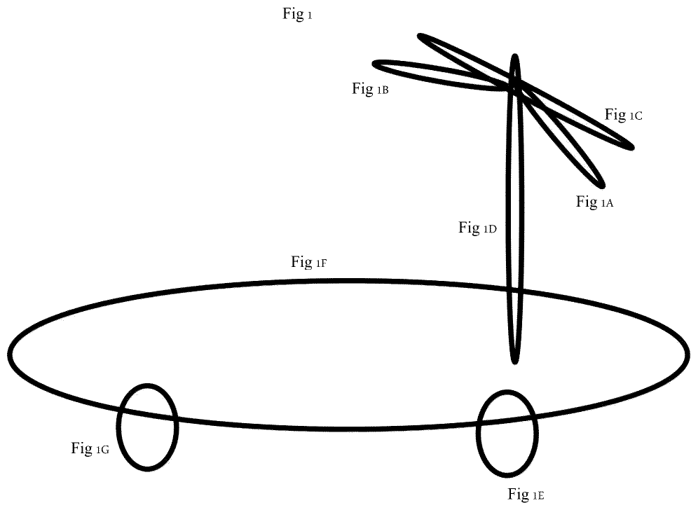

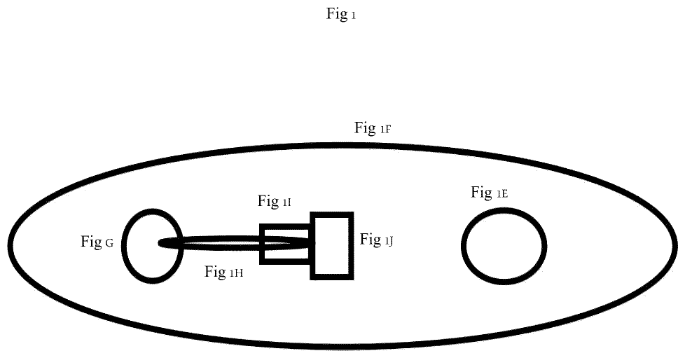

It is designed to be controlled and stopped by Handbrakes FIG. 1A (Right) and FIG. 1B (Left) which is connected to the Handle brake rod FIG. 1D. The front wheel FIG. 1E gives it better control around turns. The center has a battery FIG. 1J.

This is a two-wheel toy with electric motor FIG. 1 with hand break/s FIG. 1A front brakes and FIG. 1B rear brakes.

It has the compacity to move 2000 lbst by electric motor FIG. 1J from an electric motor assembly FIG. 1H (The Shaft) and FIG. 1G (The rear wheel FIG. 1G connected to the shaft FIG. 1H and motor FIG. 1J).

The wheels FIG. 1E (front), FIG. 1G (rear) glide on grounds of grass, dirt, or concrete. The Platform FIG. 1F to the handlebars rod FIG. 1D to Throttle FIG. 1C is configured with handbrakes FIG. 1A (Front Brakes) and FIG. 1B (Rear Brakes).

The driving apparatus for proportion is the Electric motor FIG. 1J and Shaft FIG. 1H to the rear wheel FIG. 1G. This two-wheel toy is powered by a conventional battery FIG. 1I for a power source.

### DESCRIPTION

This is a two-wheel toy with electric motor FIG. 1 with hand break/s FIG. 1A front brakes and FIG. 1B rear brakes. It has the compacity to move 2000 lbst by electric motor FIG. 1J from an electric motor assembly FIG. 1H (The Shaft) and FIG. 1G (The rear wheel FIG. 1G connected to the shaft FIG. 1H and motor FIG. 1J).

The wheels FIG. 1E (front), FIG. 1G (rear) glide on grounds of grass, dirt, or concrete. The Platform FIG. 1F to the handlebars rod FIG. 1D to Throttle FIG. 1C is configured with handbrakes FIG. 1A (Front Brakes) and FIG. 1B (Rear Brakes).

The driving apparatus for proportion is the Electric motor FIG. 1J and Shaft FIG. 1H to the rear wheel FIG. 1G. This two-wheel toy is powered by a conventional battery FIG. 1I for a power source.

1. The first weight test was with a 1979 Celica Toyota manual transmission shift starter motor at weights of 2000+lbs.

2. The second weight test was with a 1980, 1981 Nissan 280ZX manual transmission shift starter motor.

3. The two wheel toy with electric motor FIG. 1 has a Throttle FIG. 1C, Hand Brake FIG. 1A (Right) and FIG. 1B (Left) connect to the handlebar rod FIG. 1D connected to the platform FIG. 1F.

4. The strength of the motor FIG. 1J is a plus amps, volts and resistance motor to the drive configuration with the battery FIG. 1I, FIG. 1H (Shaft), FIG. 1E (Rear Wheel), FIG. 1J (Motor), and FIG. 1G (Front Wheel).

5. This depends on the person riding. The differential shaft FIG. 1H is placed at the base of the wheel FIG. 1E on the Platform FIG. 1F.
The first weight test was with a 1979 Celica Toyota manual transmission shift starter motor at weights of 2000+lbs. The second weight test was with a 1980, 1981 Nissan 280ZX manual transmission shift starter motor.
The two wheel toy with electric motor FIG. 1 has a Throttle FIG. 1C, Hand Brake FIG. 1A (Right) and FIG. 1B (Left) connect to the handlebar rod FIG. 1D connected to the platform FIG. 1F. The strength of the motor FIG. 1J is a plus amps, volts and resistance motor to the drive configuration with the battery FIG. 1I, FIG. 1H (Shaft), FIG. 1E (Rear Wheel), FIG. 1J (Motor), and FIG. 1G (Front Wheel).
This depends on the person riding. The differential shaft FIG. 1H is placed at the base of the wheel FIG. 1E on the Platform FIG. 1F.
